(19) United States
(12) Patent Application Publication
(10) Pub. No.: US 2025/0274834 A1
(43) Pub. Date: Aug. 28, 2025

(54) ENHANCED MOBILITY NODE OUTAGE IMPACT REPORTING

(71) Applicant: T-Mobile USA, Inc., Bellevue, WA (US)

(72) Inventor: Muhammad Tawhidur RAHMAN, Bellevue, WA (US)

(21) Appl. No.: 18/586,412

(22) Filed: Feb. 23, 2024

(51) Int. Cl. H04W 36/30; H04W 36/00

(52) U.S. Cl. CPC H04W 36/305; H04W 36/0058

(57) ABSTRACT

Improved mobility node (e.g., MME/AMF) outage impact reporting is more accurate than prior approaches. Rather than assuming that all UEs, attached to a mobility node upon the onset of an outage, are affected, the new approach recognizes that UEs already in connected mode, or that do not receive any incoming communication (e.g., incoming calls), are not significantly impacted. Further, the time of the impact for a UE does not start until a communication is missed. And further, some UEs may automatically attach to a second mobility node, such as another node in the same pool or due to the UE moving to a new area under the responsibility of a functioning mobility node. A scheme is disclosed for searching logs of different network nodes to identify which UEs are actually impacted by an outage, when the impact began for each, and if any recovered early using another mobility node.

### BACKGROUND

In some wireless networks, such as cellular networks, user equipment (UE) moves around among coverage of different base stations. When a UE is not in use, it moves from a connected mode (where it has an active connection with a base station) to idle mode. For the UE to receive an incoming communication, such as a call or incoming data (e.g., push email and text messages) the UE needs to return to connected mode. However, the UE may have moved location since the previous time it was in connected mode. So the wireless network cannot merely send the message from the base station that was most recently used by the UE, and hope the UE receives it.

Instead, the wireless network pages the UE from possibly multiple base stations in some geographic region where the UE had last been reported. The geographic region is large enough to allow for some typical movement of a UE. If that doesn't work, the wireless network expands the geographic area for paging, until the UE is found. The paging is accomplished using mobility nodes, each of which is responsible for some geographic area and is connected to multiple base stations. When the UE receives the paging, it responds using a base station with sufficient signal quality, registering with the wireless network, and becoming “attached” to one of the mobility nodes that is in communication the base station. (Mobility nodes are often pooled with others, with overlapping connections to the base stations for fail-overs.)

When he UE has completed registering with the wireless network, and is back in connected mode, it is able to receive the incoming communication. However, if the mobility node to which the UE is attached is experiencing an outage, the paging will fail, and the incoming communication will be missed.

### SUMMARY

The following summary is provided to illustrate examples disclosed herein, but is not meant to limit all examples to any particular configuration or sequence of operations.

Solutions are disclosed that provide enhanced mobility node outage impact reporting. Examples determine an outage period for an outage of a first mobility node of a wireless network, the outage period having an outage start time and an outage end time; determine a first set of user equipment (UEs) that, at the outage start time, had been attached to the first mobility node; determine, as a second set of UEs, UEs within the first set of UEs that experienced a missed incoming communication from the wireless network during the outage period; determine, for each UE of the second set of UEs, an impact period having an impact start time and an impact end time, wherein the impact start time is based on at least an earliest time of the missed incoming communication from the wireless network for that UE, and wherein the impact end time is no later than the outage end time; determine an aggregate impact based on at least the impact period of each UE of the second set of UEs; and generate an alert indicating the aggregate impact.

### BRIEF DESCRIPTION OF THE DRAWINGS

The disclosed examples are described below with reference to the accompanying drawing figures listed below, wherein:

FIG. 1 illustrates an exemplary architecture that advantageously provides enhanced mobility node outage impact reporting;

FIG. 2 illustrates an extended wireless network, which includes the architecture of FIG. 1;

FIG. 3 illustrates a notional time-based graph of a mobility node outage scenario for the wireless network of the architecture of FIG. 1;

FIG. 4 illustrates an exemplary chart of user equipment (UEs) experiencing different degrees of impact for the mobility node outage scenario of FIG. 3;

FIGS. 5A, 5B, and 5C illustrate stages of enhancing an estimate of the impact of the mobility node outage scenario of FIG. 3, using further insight provided, at least in part, by the chart of FIG. 4;

FIG. 6 illustrates a remediation scenario that is enabled by examples of the architecture of FIG. 1;

FIGS. 7 and 8 illustrate flowcharts of exemplary operations associated with examples of the architecture of FIG. 1; and

FIG. 9 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Improved mobility node (e.g., MME/AMF) outage impact reporting is more accurate than prior approaches. Rather than assuming that all UEs, attached to a mobility node upon the onset of an outage, are affected, the new approach recognizes that UEs already in connected mode, or that do not receive any incoming communication (e.g., incoming calls), are not significantly impacted. Further, the time of the impact for a UE does not start until a communication is missed. And further, some UEs may automatically attach to a second mobility node, such as another node in the same pool or due to the UE moving to a new area under the responsibility of a functioning mobility node. A scheme is disclosed for searching logs of different network nodes to identify which UEs are actually impacted by an outage, when the impact began for each, and if any recovered early using another mobility node.

Aspects of the disclosure improve the functioning and efficiency of wireless networks by enabling a more accurate view of the impacts of various mobility node outages. This permits efficient allocation of resources for remediation, for example by prioritizing and steering reconfiguration efforts to mobility nodes whose outages produce the greatest impact. These advantageous results are accomplished, at least in part by, determining, as a second set of UEs, UEs within a first set of UEs (attached a mobility node having an outage) that experienced a missed incoming communication from the wireless network during the outage period; and determining, for each UE of the second set of UEs, an impact period having an impact start time and an impact end time, wherein the impact start time is based on at least an earliest time of the missed incoming communication from the wireless network for that UE.

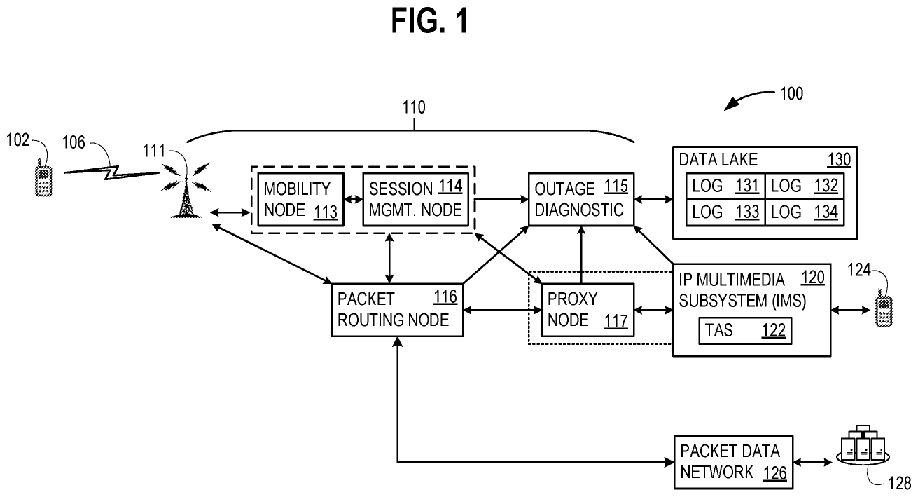

With reference now to the figures, FIG. 1 illustrates an exemplary architecture 100 that advantageously provides enhanced mobility node outage impact reporting. A wireless network 110 is illustrated that is serving a UE 102. UE 102 may be an eMBB (e.g., a cellular telephone such as a smartphone), but may also represent other telecommunication devices capable of using a wireless network, such as an FWA, IoT, M2M, or personal computer (PC, e.g., desktop, notebook, tablet, etc.) with a cellular modem. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 124. Wireless network 110 may be a cellular network such as a fifth generation (5G) network, a fourth generation (4G) network, or another cellular generation network.

UE 102 uses an air interface 106 to communicate with a base station 111 of wireless network 110, such that base station 111 is the serving base station for UE 102 (providing the serving cell). In some scenarios, base station 111 may be referred to as a radio access network (RAN). Wireless network 110 has a mobility node 113, a session management node 114, an outage diagnostic node 115, and other components (not shown). Wireless network 110 also has a packet routing node 116 and a proxy node 117. Mobility node 113 and session management node 114 are within a control plane of wireless network 110, and packet routing node 116 is within a data plane (a.k.a. user plane) of wireless network 110.

Base station 111 is in communication with mobility node 113 and packet routing node 116. Mobility node 113 is in communication with session management node 114, which is in communication with packet routing node 116 and proxy node 117. Packet routing node 116 is in communication with proxy node 117, and packet data network 124. In some 5G examples, base station 111 comprises a gNodeB (gNB), mobility node 113 comprises an access mobility function (AMF), session management node 114 comprises a session management function (SMF), and packet routing node 116 comprises a user plane function (UPF).

In some 4G examples, base station 111 comprises an eNodeB (eNB), mobility node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 117 is in communication with an internet protocol (IP) multimedia system (IMS) access gateway (IMS-AGW) within an IMS 120, in order to provide connectivity to other wireless (cellular) networks, such as for a call with UE 124 or a public switched telephone system (PSTN, also known as plain old telephone system, POTS). IMS 120 has a telephony application server (TAS) 122 to provide for phone call signaling. In some examples, proxy node 117 may be considered to be within IMS 120. UE 102 reaches network resource 126 using packet data network 124 (or IMS 120, in some examples). Data packets from UE 102 pass through at least base station 111 and packet routing node 116 on their way to packet data network 124 or IMS 120 (via proxy node 117).

Outage diagnostic node 115 contains the logic needed for the enhanced mobility node outage impact reporting, which is described in further detail below. Outage diagnostic node 115 uses various data logs from differing nodes of wireless network 110 and roaming partner networks (an example of which is shown in FIG, 2). In some examples, these data logs may be stored in a data lake 130 for retrieval by outage diagnostic node 115 when needed. The illustrated example shows four data logs within data lake 130, a data log 131, a data log 132, a data log 133, and a data log 134, although examples may use a larger number of data logs.

Although FIG. 1 and some of the following figures are described using an example of a cellular network, it should be understood that the teachings herein are applicable to other types of wireless networks. To benefit from the teachings herein, another type of wireless network should operate such that paging is used by the wireless network to cause mobile units (equivalents of UE 102) to move to a connected state. The wireless network node that instructs radio base stations of the wireless network to perform the paging may then be considered to be equivalents of mobility node 113.

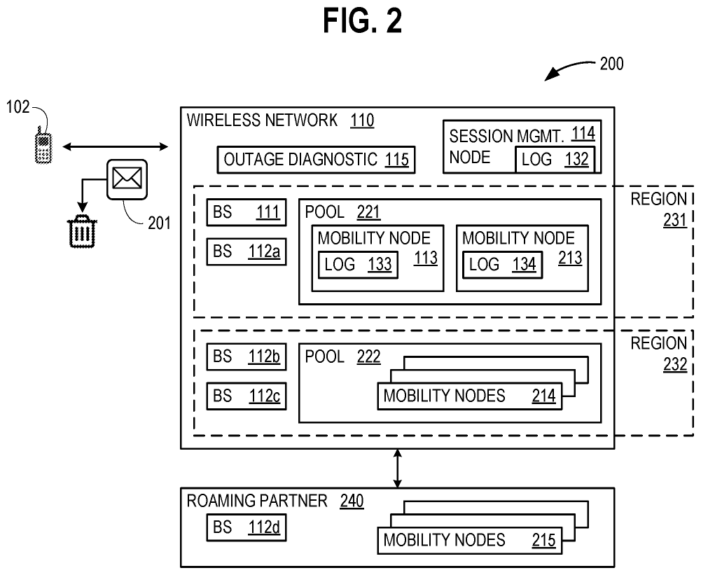

FIG. 2 illustrates an extended wireless network 200, which wireless network 110. As shown, UE 102 is originally attached mobility node 113 through base station 111 when mobility node 113 experiences an outage and an incoming communication, shown as a missed incoming communication 201, fails to reach 102 as a result of the outage. Missed incoming communication 201 may be an incoming phone call from UE 124 or an incoming text message (SMS) or an incoming push email notification. Outage diagnostic node 115 is able to determine that UE 102 is one of the UEs that is attached to mobility node 113 at the onset (start time) of the outage using data log 133 from mobility node 113 (either retrieved directly from mobility node 113, or from data lake 130).

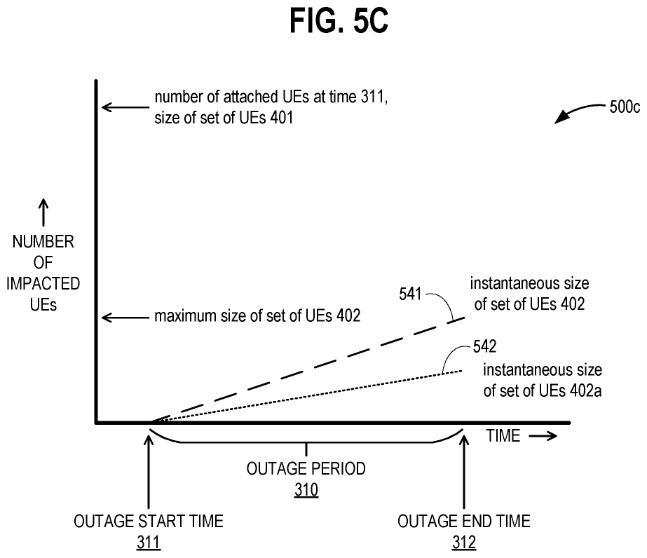

Outage diagnostic node 115 is able to determine that UE 102 is one of the UEs that is actually impacted by the outage of mobility node 113 by identifying missed incoming communication 201 using either data log 133 from session management node 114 (either retrieved directly from session management node 114, or from data lake 130), or data log 131 from TAS 122 (as shown later, in FIG. 5A). In some scenarios, UE 102 may move a few miles and be within the region of coverage of another nearby base station 112a, or base station 112a is a different cellular generation base station. In such scenarios, another mobility node 213 is able to find UE 102 when another incoming communication arrives for UE 102.

UE 102 then attaches to mobility node 213, which is indicated in data log 134. If this occurs, outage diagnostic node 115 is able to identify that UE 102 recovers from the outage early (i.e., before mobility node 113 recovers from the outage), which limits the time of the impact (the impact period) for UE 102. As illustrated, mobility node 113 and mobility node 213 are within a mobility node pool 221, which also includes other mobility nodes (not shown) that also have their own versions of data log 134. In operation, upon outage diagnostic node 115 identifying UE 102 is one of the UEs that is actually impacted by the outage of mobility node 113, outage diagnostic node 115 searches for an indication UE 102 attached to another mobility node within data logs of other mobility nodes that are feasible for UE 102 to have reached. The search stars within other mobility nodes of mobility node pool 221.

Mobility nodes are often pooled according to geographic regions. Mobility node pool 221 is in geographical region 231. An adjacent geographical region 232 has a mobility node pool 222 with other mobility nodes 214 that are connected to a base station 112b and a base station 112c. It is possible that, during the outage of mobility node 113, UE 102 was in motion (e.g., in a vehicle on a road), and moved to within coverage of base station 112b or base station 112c. So, outage diagnostic node 115 will search within data logs of other mobility nodes 214 of mobility node pool 222 within geographical region 232, while possibly foregoing searching within data logs of other mobility nodes that are further away (e.g., more than some threshold distance).

Other data logs that may be searched are data logs for different cellular generation mobility nodes of wireless network 110 in geographical regions 231 and 232, as well as data logs for roaming partner networks' mobility nodes. An exemplary roaming partner 240 is shown having a base station 112d and mobility nodes 215.

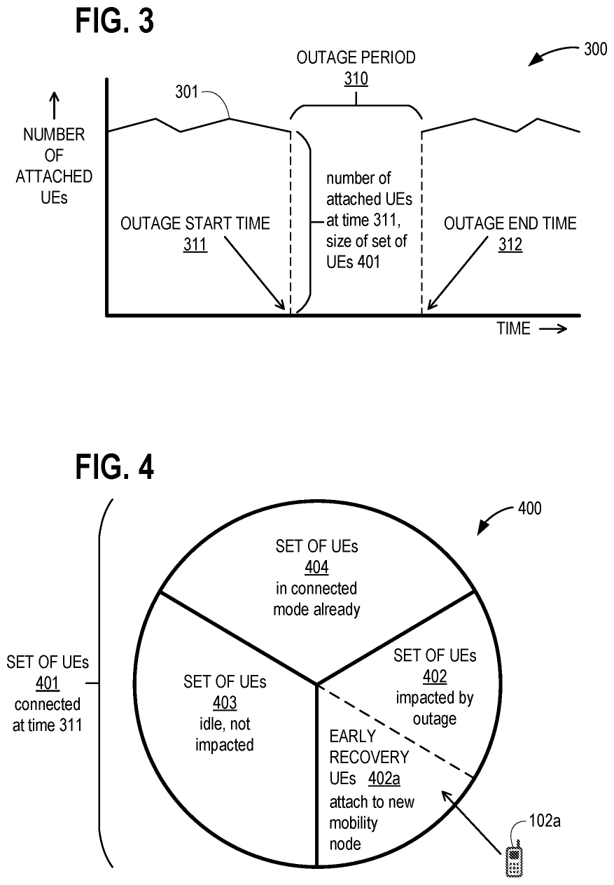

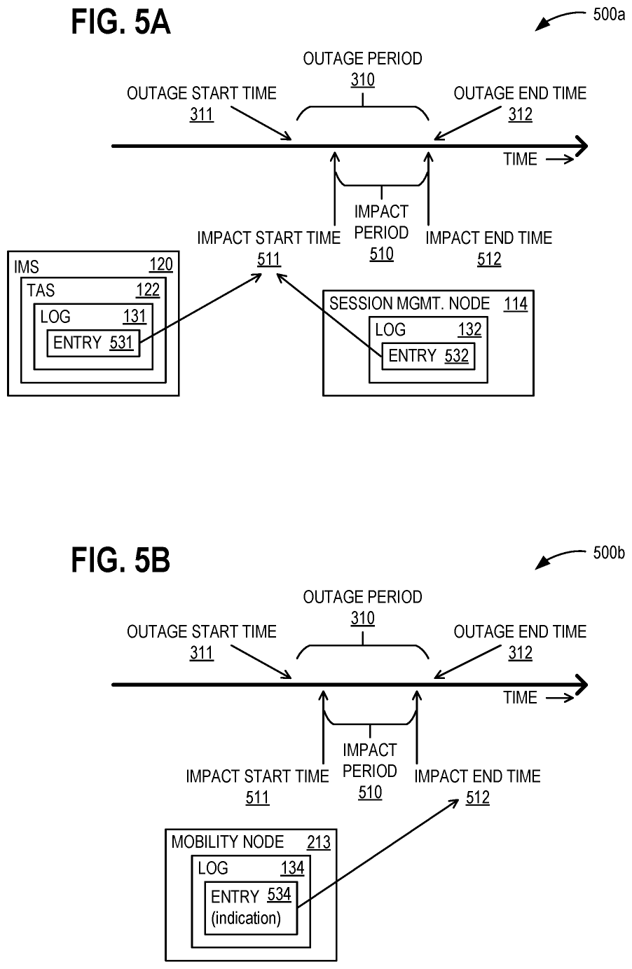

FIG. 3 illustrates a notional time-based graph 300 of a mobility node outage scenario for mobility node 113. The number of attached UEs 301, which are attached to mobility node 113, is plotted as a function of time. An outage has an outage period 310, commencing upon an outage start time 311, and concluding with an outage end time 312. Number of attached UEs 301 at outage start time 311 is the size of a set of UEs 401 shown in FIG. 4.

FIG. 4 illustrates an exemplary pie chart 400 of UEs experiencing different degrees of impact for the mobility node outage scenario of FIG. 3. A simplistic measure of outage impact, using simple numbers is provided as: Number of attached UEs 301=1000; outage period 310=100 minutes; maximum potential aggregate impact=1000×100=100,000 user minutes.

However, as noted previously, not every UE may be affected. Using a simple uniform distribution of possibilities, ⅓^{rd} of the UEs are and remain idle, with no incoming communication, ⅓^{rd} of the UEs are and remain in connected mode, and ⅓^{rd} of the UEs have a missed communication.

A set of UEs 402 has those UEs of set of UEs 401 that have a missed incoming communication 201. A set of UEs 403 has those UEs of set of UEs 401 that remain idle and do not have any missed incoming communication. A set of UEs 404 has those UEs of set of UEs 401 that remain in connected mode and those do not require paging. This assessment of UE situation drops the aggregate impact to ⅓^{rd} of its previous value, down to 33,333 user minutes at the worst case. And this number 33,333 assumes that missed incoming communication 201 for each UE in set of UEs 402 arrives immediately upon outage start time 311. This is unlikely to be the case, driving the aggregate impact down further.

However, an even further reduction in the determination of the aggregate impact is also possible. A set of early recovery UEs 402a has those UEs of set of UEs 402 that attach to mobility node 213 (whether within mobility node pool 221, mobility node pool 222, roaming partner 240, or a different cellular generation mobility node) prior to outage end time 312. This means that, for UEs in set of early recovery UEs 402a, the outage impact ends early. A representative early recovery UE 102a, which is in set of early recovery UEs 402a, is shown.

FIG. 5A illustrates the delay of the impact for a UE on a timeline 500a, when measuring the impact using an impact period 510 that commences upon an impact start time 511 and concludes with an impact end time 512. Impact start time 511 is determined individually for each UE, using the earliest time of any missed incoming communication 201 for that UE. If there are multiple missed incoming communications 201 for a single UE, only the first one (the earliest in time) is used.

The timing of each missed incoming communication 201 is determined by event timestamps in data log entries in data logs from wireless network nodes that are in the signaling pathway for missed incoming communications 201. For voice calls, this is TAS 122 in IMS 120. The signaling may be session initiation protocol (SIP) signaling, and a log entry 531 in data log 131, that gives the time of missed incoming communication 201 may be “SIP 480 not reachable”. Alternatively, for voice and data (e.g., email) traffic, data log 132 from session management node 114 is used, because session management node 114 is the final node through which signaling passes, prior to reaching mobility node 113. Using data log 132 from session management node 114 reduces the likelihood of a false alarm when the signaling failure is caused by a node other than mobility node. When using data log 132, the signaling may be a downlink data notification (DDN), and a log entry 532 in data log 132, that gives the time of missed incoming communication 201 may be “DDN timeout” or “DDN reject”.

For the scenario indicated by FIG. 5A, impact end time 512 coincides with outage end time 312. This is the default when outage diagnostic node 115 is unable to identify an early recover for a UE. However, for the scenario indicated by FIG. 5B, outage diagnostic node 115 is able to identify an early recover for a UE, so impact end time 512 is earlier than outage end time 312.

Outage diagnostic node 115 locates an indication 534 as a log entry in data log 134 of mobility node 213. Mobility node 213 represents any mobility node to which UE 102 connects (which renders it early recovery UE 102a), and may be in any of mobility node pool 221, mobility node pool 222, roaming partner 240, or may be a different cellular generation mobility node.

FIG. 5C illustrates a notional time-based graph 500c for an enhanced mobility node outage impact determination. Set of UEs 402 grows with time as missed incoming communication 210 for more and more UEs arrive, starting at outage start time 311, and stopping the growth at outage end time 312. Even though set of UEs 402 grows with time, it remains below the size of set of UEs 401—using the simple example described previously, only up to ⅓^{rd}. This is shown as a time-dependent count 541. Another time-dependent count 524 shows set early recovery UEs 402a also growing with time, as more and more UEs attach to other mobility nodes 113.

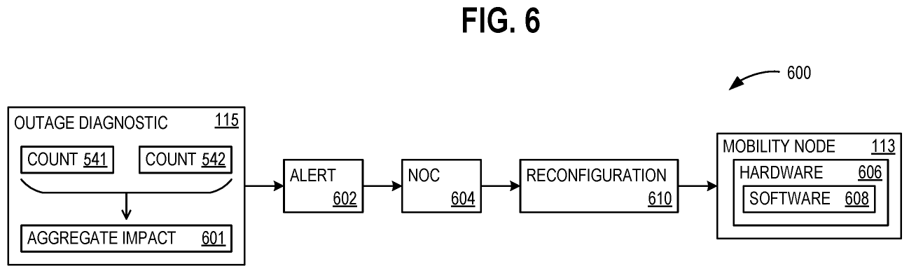

FIG. 6 illustrates a remediation scenario 600 that is enabled by examples of architecture 100. Outage diagnostic node 115 uses time-dependent count 541 and time-dependent count 541 to determine an aggregate impact 601 as the total number of user minutes of the outage of mobility node 113. Outage diagnostic node 115 generates an alert 602 indicating aggregate impact 601 for a network operations center (NOC) 604 or another location designated by the operator of wireless network 110. If aggregate impact 601 is sufficiently severe, resources are prioritized for some repair or reconfiguration of mobility node 113.

Mobility node 113 has hardware 606 and software 608, and the remediation is illustrated as a software reconfiguration 610 for software 608 of mobility node 113. Other remediation efforts may also be performed to reduce the likelihood of another outage having the severity indicated by aggregate impact 601.

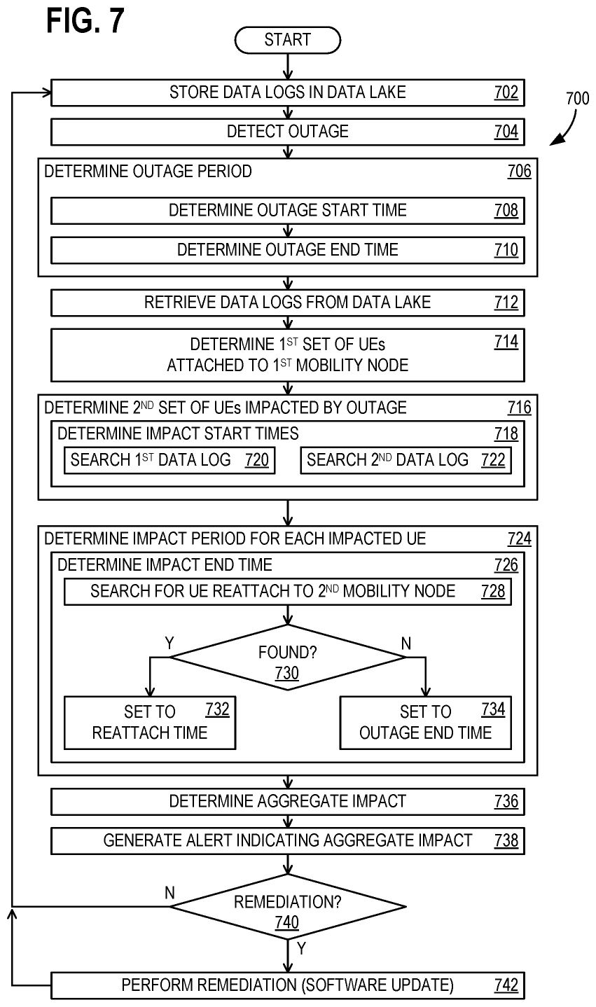

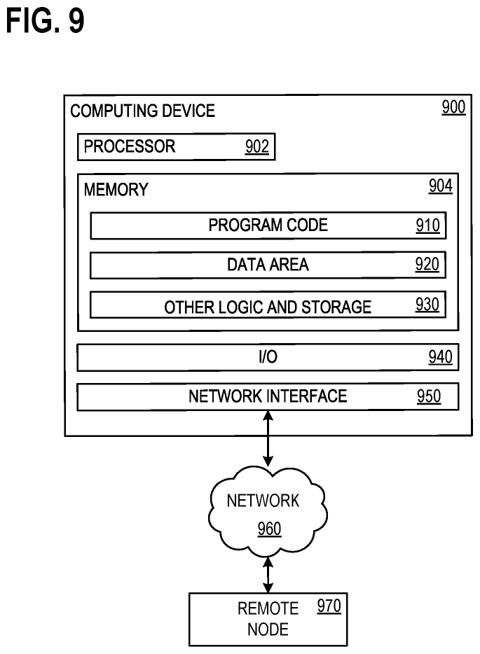

FIG. 7 illustrates a flowchart 700 of exemplary operations associated with architecture 100. In some examples, at least a portion of flowchart 700 may be performed using one or more computing devices 900 of FIG. 9. Flowchart 700 commences with various nodes of wireless network 110 and extended wireless network 200 storing their data logs (e.g., data log 131, data log 132, data log 133, and data log 134) in data lake 130, in operation 702. Operation 702 is an ongoing process.

An outage of mobility node 113 is detected in operation 704. Operation 706 determines outage period 310 for an outage of mobility node 113, using operations 708 and 710. Operation 708 determines outage start time 311 and operation 710 determines outage end time 312. In operation 712, outage diagnostic node 115 retrieves data log 131, data log 132, data log 133, and data log 134 from data lake 130 for searching for relevant information. Outage diagnostic node 115 determines set of UEs 401 that, at outage start time 311, had been attached to mobility node 113, for example by using data log 133 for mobility node 113, in operation 714.

Outage diagnostic node 115 determines set of UEs 402 as UEs, within set of UEs 401, which experienced missed incoming communication 201 from wireless network 110 during outage period 310, operation 716. This is performed using operation 718, which determines impact start times based on at least an earliest time of missed incoming communication 201 from wireless network 110 for each UE that joins set of UEs 402. Operation 718 may be performed using operation 720 or 722. Operation 720 searches data log 131 to determine impact start time 511, whereas operation 722 searches data log 132 to determine impact start time 511.

Operation 724 determines, for each UE of set of UEs 402, that UE's impact period 510. Impact start time 511 is already known from operation 718, and impact end time 512 is found using operation 726. Operation 726 is shown as differentiated into operations 728-734. Operation 728 searches for indication 534, that a UE (designated early recovery UE 102a) attached to mobility node 213. The searching may be within data logs of the mobility nodes in mobility node pool 221, mobility nodes 214 in mobility node pool 222, different cellular generation mobility nodes of wireless network 110 in geographical region 231, and mobility nodes 215 of roaming partner 240.

Decision operation 730 determines whether indication 534 is found a UE, and is performed for each UE within set of UEs 402. If indication 534 is found, operation 732 sets impact end time 512 as no later than a time that early recovery UE 102a attached to mobility node 213. Otherwise, operation 734 sets impact end time 512 to the default value as no later than outage end time 312.

Aggregate impact 601 is determined in operation 736, based on at least impact period 510 of each UE of set of UEs 402. In some examples, this is accomplished by summing impact periods 510 for UE 102s of set of UEs 402. Alert 602 is generated in operation 738, indicating aggregate impact 601. Decision operation 740 determines whether aggregate impact 601 exceeds some impact threshold. If so, operation 742 initiates software reconfiguration 610 of mobility node 113.

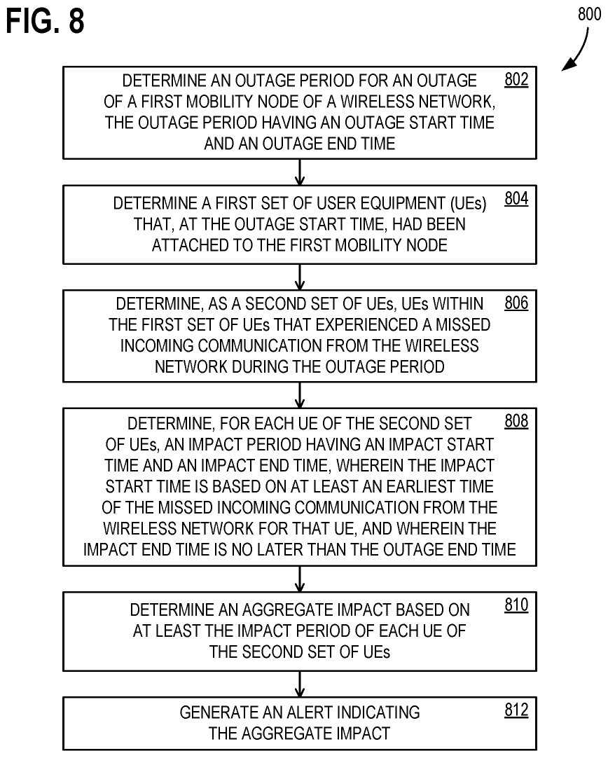

FIG. 8 illustrates a flowchart 800 of exemplary operations associated with examples of architecture 100. In some examples, at least a portion of flowchart 800 may be performed using one or more computing devices 900 of FIG. 10. Flowchart 800 commences with operation 802, which includes determining an outage period for an outage of a first mobility node of a wireless network, the outage period having an outage start time and an outage end time. Operation 804 includes determining a first set of UEs that, at the outage start time, had been attached to the first mobility node. Operation 806 includes determining, as a second set of UEs, UEs within the first set of UEs that experienced a missed incoming communication from the wireless network during the outage period.

Operation 808 includes determining, for each UE of the second set of UEs, an impact period having an impact start time and an impact end time, wherein the impact start time is based on at least an earliest time of the missed incoming communication from the wireless network for that UE, and wherein the impact end time is no later than the outage end time. Operation 810 includes determining an aggregate impact based on at least the impact period of each UE of the second set of UEs. Operation 812 includes generating an alert indicating the aggregate impact.

FIG. 9 illustrates a block diagram of computing device 900 that may be used as any component described herein that may require computational or storage capacity. Computing device 900 has at least a processor 902 and a memory 904 that holds program code 910, data area 920, and other logic and storage 930. Memory 904 is any device allowing information, such as computer executable instructions and/or other data, to be stored and retrieved. For example, memory 904 may include one or more random access memory (RAM) modules, flash memory modules, hard disks, solid-state disks, persistent memory devices, and/or optical disks. Program code 910 comprises computer executable instructions and computer executable components including instructions used to perform operations described herein. Data area 920 holds data used to perform operations described herein. Memory 904 also includes other logic and storage 930 that performs or facilitates other functions disclosed herein or otherwise required of computing device 900. An input/output (I/O) component 940 facilitates receiving input from users and other devices and generating displays for users and outputs for other devices. A network interface 950 permits communication over external network 960 with a remote node 970, which may represent another implementation of computing device 900. For example, a remote node 970 may represent another of the above-noted nodes within architecture 100.

### Additional Examples

An example system comprises: a processor; and a computer-readable medium storing instructions that are operative upon execution by the processor to: determine an outage period for an outage of a first mobility node of a wireless network, the outage period having an outage start time and an outage end time; determine a first set of UEs that, at the outage start time, had been attached to the first mobility node; determine, as a second set of UEs, UEs within the first set of UEs that experienced a missed incoming communication from the wireless network during the outage period; determine, for each UE of the second set of UEs, an impact period having an impact start time and an impact end time, wherein the impact start time is based on at least an earliest time of the missed incoming communication from the wireless network for that UE, and wherein the impact end time is no later than the outage end time; determine an aggregate impact based on at least the impact period of each UE of the second set of UEs; and generate an alert indicating the aggregate impact.

An example method of wireless communication comprises: determining an outage period for an outage of a first mobility node of a wireless network, the outage period having an outage start time and an outage end time; determining a first set of UEs that, at the outage start time, had been attached to the first mobility node; determining, as a second set of UEs, UEs within the first set of UEs that experienced a missed incoming communication from the wireless network during the outage period; determining, for each UE of the second set of UEs, an impact period having an impact start time and an impact end time, wherein the impact start time is based on at least an earliest time of the missed incoming communication from the wireless network for that UE, and wherein the impact end time is no later than the outage end time; determining an aggregate impact based on at least the impact period of each UE of the second set of UEs; and generating an alert indicating the aggregate impact.

One or more example computer storage devices has computer-executable instructions stored thereon, which, upon execution by a computer, cause the computer to perform operations comprising: determining an outage period for an outage of a first mobility node of a wireless network, the outage period having an outage start time and an outage end time; determining a first set of UEs that, at the outage start time, had been attached to the first mobility node; determining, as a second set of UEs, UEs within the first set of UEs that experienced a missed incoming communication from the wireless network during the outage period; determining, for each UE of the second set of UEs, an impact period having an impact start time and an impact end time, wherein the impact start time is based on at least an earliest time of the missed incoming communication from the wireless network for that UE, and wherein the impact end time is no later than the outage end time; determining an aggregate impact based on at least the impact period of each UE of the second set of UEs; and generating an alert indicating the aggregate impact.

Alternatively, or in addition to the other examples described herein, examples include any combination of the following:
the wireless network comprises a cellular network;
based on at least the aggregate impact in the alert exceeding an impact threshold, initiating a software reconfiguration of the first mobility node;
the mobility node comprises an MME;
the mobility node comprises an AMF;
the impact start time for a UE is determined using a first data log, received from an IMS, with a first log entry indicating the earliest time of the missed incoming communication;
the impact start time for a UE is determined using a second data log, received from a session management node of the wireless network, with a second log entry indicating the earliest time of the missed incoming communication;
the impact end time for an early recovery UE of the second set of UEs is no later than a time the early recovery UE attached to a second mobility node;
the first mobility node is within a first mobility node pool having mobility nodes in a first geographical region;
a second mobility node pool includes mobility nodes in a second geographical region adjacent to the first geographical region;
searching for an indication, that the early recovery UE attached to the second mobility node, within data logs of: the mobility nodes in the first mobility node pool, the mobility nodes in the second mobility node pool, different cellular generation mobility nodes of the wireless network in the first geographical region, and mobility nodes of a roaming partner of the wireless network;
determining the aggregate impact comprises summing the impact periods for the UEs of the second set of UEs;
the first data log comprises a log of voice call signaling;
the first data log comprises a TAS CDR;
the first log entry indicates a SIP message;
the SIP message comprises SIP 480 not reachable;
the session management node comprises an SMF or an SAEGW-C;
the second log entry indicates a DDN timeout or DDN reject;
the second mobility node is in the first mobility node pool;
the second mobility node is in the second mobility node pool;
the second mobility node is a different cellular generation mobility node than the first mobility node;
the second mobility node is a mobility node of a roaming partner of the wireless network;
storing the first data log and the second data log in a data lake; and
retrieving the first data log and the second data log from the data lake for the searching.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
determining an outage period for an outage of a first mobility node of a wireless network, the outage period having an outage start time and an outage end time;
determining a first set of user equipment (UEs) that, at the outage start time, had been attached to the first mobility node;
determining, as a second set of UEs, UEs within the first set of UEs that experienced a missed incoming communication from the wireless network during the outage period;
determining, for each UE of the second set of UEs, an impact period having an impact start time and an impact end time, wherein the impact start time is based on at least an earliest time of the missed incoming communication from the wireless network for that UE, and wherein the impact end time is no later than the outage end time;
determining an aggregate impact based on at least the impact period of each UE of the second set of UEs; and
generating an alert indicating the aggregate impact.

2. The method of claim 1, further comprising:
based on at least the aggregate impact in the alert exceeding an impact threshold, initiating a software reconfiguration of the first mobility node.

3. The method of claim 1, wherein the mobility node comprises a mobility management entity (MME) or an access mobility function (AMF).

4. The method of claim 1, wherein the impact start time for a UE is determined using a first data log, received from an internet protocol (IP) multimedia subsystem (IMS), with a first log entry indicating the earliest time of the missed incoming communication.

5. The method of claim 1, wherein the impact start time for a UE is determined using a second data log, received from a session management node of the wireless network, with a second log entry indicating the earliest time of the missed incoming communication.

6. The method of claim 1, wherein the impact end time for an early recovery UE of the second set of UEs is no later than a time the early recovery UE attached to a second mobility node.

7. The method of claim 6, wherein the first mobility node is within a first mobility node pool having mobility nodes in a first geographical region, wherein a second mobility node pool includes mobility nodes in a second geographical region adjacent to the first geographical region, and wherein the method further comprises:
searching for an indication, that the early recovery UE attached to the second mobility node, within data logs of:
the mobility nodes in the first mobility node pool,
the mobility nodes in the second mobility node pool,
different cellular generation mobility nodes of the wireless network in the first geographical region, and
mobility nodes of a roaming partner of the wireless network.

8. A system comprising:
a processor; and
a computer-readable medium storing instructions that are operative upon execution by the processor to:
determine an outage period for an outage of a first mobility node of a wireless network, the outage period having an outage start time and an outage end time;
determine a first set of user equipment (UEs) that, at the outage start time, had been attached to the first mobility node;
determine, as a second set of UEs, UEs within the first set of UEs that experienced a missed incoming communication from the wireless network during the outage period;
determine, for each UE of the second set of UEs, an impact period having an impact start time and an impact end time, wherein the impact start time is based on at least an earliest time of the missed incoming communication from the wireless network for that UE, and wherein the impact end time is no later than the outage end time;
determine an aggregate impact based on at least the impact period of each UE of the second set of UEs; and
generate an alert indicating the aggregate impact.

9. The system of claim 8, wherein the instructions are further operative to:
based on at least the aggregate impact in the alert exceeding an impact threshold, initiating a software reconfiguration of the first mobility node.

10. The system of claim 8, wherein the mobility node comprises a mobility management entity (MME) or an access mobility function (AMF).

11. The system of claim 8, wherein the impact start time for a UE is determined using a first data log, received from an internet protocol (IP) multimedia subsystem (IMS), with a first log entry indicating the earliest time of the missed incoming communication.

12. The system of claim 8, wherein the impact start time for a UE is determined using a second data log, received from a session management node of the wireless network, with a second log entry indicating the earliest time of the missed incoming communication.

13. The system of claim 8, wherein the impact end time for an early recovery UE of the second set of UEs is no later than a time the early recovery UE attached to a second mobility node.

14. The system of claim 13, wherein the first mobility node is within a first mobility node pool having mobility nodes in a first geographical region, wherein a second mobility node pool includes mobility nodes in a second geographical region adjacent to the first geographical region, and wherein the instructions are further operative to:
search for an indication, that the early recovery UE attached to the second mobility node, within data logs of:
the mobility nodes in the first mobility node pool,
the mobility nodes in the second mobility node pool,
different cellular generation mobility nodes of the wireless network in the first geographical region, and
mobility nodes of a roaming partner of the wireless network.

15. One or more computer storage devices having computer-executable instructions stored thereon, which, upon execution by a computer, cause the computer to perform operations comprising:
determining an outage period for an outage of a first mobility node of a wireless network, the outage period having an outage start time and an outage end time;
determining a first set of user equipment (UEs) that, at the outage start time, had been attached to the first mobility node;
determining, as a second set of UEs, UEs within the first set of UEs that experienced a missed incoming communication from the wireless network during the outage period;
determining, for each UE of the second set of UEs, an impact period having an impact start time and an impact end time, wherein the impact start time is based on at least an earliest time of the missed incoming communication from the wireless network for that UE, and wherein the impact end time is no later than the outage end time;
determining an aggregate impact based on at least the impact period of each UE of the second set of UEs; and
generating an alert indicating the aggregate impact.

16. The one or more computer storage devices of claim 15, wherein the mobility node comprises a mobility management entity (MME) or an access mobility function (AMF).

17. The one or more computer storage devices of claim 15, wherein the impact start time for a UE is determined using a first data log, received from an internet protocol (IP) multimedia subsystem (IMS), with a first log entry indicating the earliest time of the missed incoming communication, and wherein the first data log comprises a telephony application server (TAS) call detail record (CDR).

18. The one or more computer storage devices of claim 15, wherein the impact start time for a UE is determined using a second data log, received from a session management node of the wireless network, with a second log entry indicating the earliest time of the missed incoming communication.

19. The one or more computer storage devices of claim 18, wherein the session management node comprises a session management function (SMF) or a system architecture evolution gateway (SAEGW) control plane (SAEGW-C), and wherein the second log entry indicates a Downlink Data Notification (DDN) timeout or DDN reject.

20. The one or more computer storage devices of claim 15, wherein the impact end time for an early recovery UE of the second set of UEs is no later than a time the early recovery UE attached to a second mobility node.
